(19) United States
(12) Patent Application Publication
(10) Pub. No.: US 2026/0036168 A1
(43) Pub. Date: Feb. 5, 2026

(54) SPHERICAL ROLLER BEARING HAVING ASYMMETRIC CAGE POCKETS

(71) Applicant: AKTIEBOLAGET SKF, GOTEBORG (SE)

(72) Inventors: Alexei JOLKIN, Göteborg (SE); Stefan Manfred WEIGAND, Rannungen (DE); Juergen REICHERT, Donnersdorf (DE); Sabine HOFMANN, Kürnach (DE); Sankar RAMACHANDRAN, Mölndal (SE)

(21) Appl. No.: 19/276,054

(22) Filed: Jul. 22, 2025

(30) Foreign Application Priority Data
Jul. 30, 2024 (DE) 102024207178.1

(51) Int. Cl. F16C 33/54; F16C 19/38

(52) U.S. Cl. CPC F16C 33/541; F16C 33/543; F16C 19/38; F16C 2360/31

(57) ABSTRACT

A spherical roller bearing includes an inner ring, an outer ring, spherical rollers and a cage. The cage has an axially inner ring and an axially outer ring connected by a plurality of cage bars to form pockets to hold the rollers. Each cage bar has an axially extending curvature in the circumferential direction that is at least partially concave, and an axial distance between an apex of the curvature and an axial inner pocket side face is not equal to and preferably larger than a distance between the apex of the curvature and an axial outer pocket side face.

### CROSS-REFERENCE

This application claims priority to German patent application no. 10 2024 207 178.1 filed on Jul. 30, 2024, the contents of which are fully incorporated herein by reference.

### TECHNOLOGICAL FIELD

The present disclosure relates to a spherical roller bearing and to a bearing arrangement comprising a spherical roller bearing.

### BACKGROUND

Rolling bearings are common mechanical components for many different applications. There are different types of rolling bearings that are designed to meet different requirements. Depending on the conditions of the particular application, i.e., the load level, the rotational speed, the temperature, etc., there are different types of suitable rolling bearings.

A common type of bearing is a spherical roller bearing. The bearing is designed to accommodate large radial loads and axial loads, and it is also designed to accommodate flexing of a shaft supported by the bearings, i.e., the bearing rings can be relatively misaligned. Therefore, such bearings are particularly suitable for more demanding industrial applications such as machines in wind turbines and the like.

In most demanding industrial applications for spherical roller bearings, the most bearing failures are usually related to increased surface-initiated fatigue such as wear. One reason that increased wear occurs may be caused by a displacement of the spherical rollers in the cage which may lead to undesired contact between surfaces and/or increased stress, particularly on the cage. By reducing these undesired contacts and/or stresses a service life of the bearing may increase.

It is therefore object of the present disclosure to provide a spherical roller bearing having an improved service life.

### SUMMARY

In the following, a spherical roller bearing is described. The spherical roller bearing may be used for supporting a wind turbine main shaft.

The spherical roller bearing comprises at least an outer ring and an inner ring and two set of spherical rollers that are configured to roll along raceways formed on the outer and inner ring, and at least one cage configured to retain the rollers. The inner ring has a bore with a diameter of at least 499 mm, preferably at least 699 mm, and even more preferred at least 899 mm. The bore may be adapted to receive a component of another machine, for example a shaft of a wind turbine.

The inner ring may be formed with or without flanges on an axial inner side and/or an axial outer side. If the inner ring is equipped with flanges, flanges may be used as guide flanges for the roller elements. Furthermore, they may also serve as retaining flanges for preventing the rollers from falling out of the bearings.

The at least one cage comprises at least one axial inner cage ring extending in a circumferential direction of the bearing, a first axial outer cage ring spaced from the at least one axial inner cage ring on a first axial side and connected to it with a plurality of cage bars thereby forming closed pockets, wherein each pocket is configured to receive one spherical roller of the first set of rollers and has an axial inner side face and an axial outer side face configured to confine the received spherical roller in the axial direction, and a second axial outer cage ring spaced from the at least one axial inner cage ring on a second axial side opposite of the first axial side and connected to it with a plurality of cage bars thereby forming closed pockets, wherein each pocket is configured to receive one spherical roller of the second set of rollers and has an axial inner pocket side face and an axial pocket outer side face configured to confine the received spherical roller in the axial direction.

The axial inner pocket side face and an axial outer pocket side face may be formed by the axial inner and outer cage ring and/or an element connected to the axial inner and outer cage ring.

In particular, the inventors made the observation that window-type cages in spherical roller bearings may tend to shift during operation to an inner side of the spherical roller bearing. This can lead to increased wear on the at least one cage and/or the spherical rollers and/or increased stress in the at least on cage. Both increased wear and increased stress may result in a reduced service life of the spherical roller bearing.

Thus, to improve a service life of the spherical roller bearing, each cage bar has an axially extending curvature in the circumferential direction, wherein the curvature is at least partially concave, and wherein, in the axial direction, a distance between an apex of the curvature and the axial inner pocket side face differs from a distance between the apex of the curvature and the axial outer pocket side face. For example, the difference between the distance between the apex of the curvature and the axial inner pocket side face and the distance between the apex of the curvature and the axial outer pocket side face may be 0.5 mm, preferably 1 mm.

Providing the cage bar with a curvature in the circumferential direction such that the distance between the apex of the curvature and the axial inner pocket side face differs from the distance between the apex of the curvature and the axial outer pocket side face allows a position of the spherical roller the cage pocket to shift towards the outside of the spherical roller bearing. This may further compensate for an axial displacement between the spherical roller and the cage due to gravity and/or contact angle. This may reduce a wear on the cage and/or the spherical rollers, thereby improving a service life of the spherical roller bearing.

According to a further embodiment, the distance between the apex of the curvature and the axial inner pocket side face may be larger than the distance between the apex of the curvature and the axial outer pocket side face.

This may allow a defined positional relation to be provided between the at least one cage and the spherical roller which can lead to a reduced relative motion between the cage and the spherical roller. Reducing the relative motion between the cage and the spherical roller may reduce contact stresses on the at least one cage. More specifically, in order to prevent any occurrences of undesired interferences between the cage and the spherical roller a minimal axial play between the roller and axial inner pocket side face and axial outer pocket side face should be maintained. Since the direction is known to which the cage may tend to move, it may be possible to design the cage such that a surface of the cage, which is most likely coming into contact with the spherical roller anyways, may be already configured as a contact surface, thereby allowing to make any tolerance compensations on another surface. This may further allow the total tolerance deviations to be kept small.

According to a further embodiment, a radius of the curvature may be adapted to form an osculation with a crowning of the spherical roller.

In particular, a well determined position of a contact between the cage bar and the spherical roller which may be achieved by adapting the radius of the circumferential cage bar side face in the axial direction to form an osculation with the crowning of the spherical roller may allow for an improved contact between the cage bar and the spherical roller. This may reduce a contact stress between the spherical roller and the cage bar.

In particular, the osculation may be between 100% and 104%, preferably between 100.5% and 103%. Moreover, the osculation may be defined by the radius of the curvature of the cage bar divided by the radius of the crowning of the spherical roller.

In particular, an osculation of 100% may be referred to as a very tight osculation, while an osculation of 104% may be referred to as a very loose osculation. Furthermore, a loose osculation may lead to increased contact stresses in a center position of the cage and may result in a smaller contact ellipse. On the other hand, a tighter osculation may lead to reduced contact stresses in center position and may result in a larger contact ellipse.

According to a further embodiment, an outer axial clearance between the axial outer pocket side face and an outer axial side face of the spherical roller is smaller than an inner axial clearance between the at least one axial inner pocket side face and an inner axial side face of the spherical roller.

A smaller outer axial clearance between the axial outer pocket side face and an outer axial side face of the spherical roller compared to the inner axial clearance between the axial inner pocket side face and an inner axial side face of the spherical roller may result in a more precisely defined spherical roller position in the pocket in operation. This may reduce the cage bar contact stress in operation and may improve the overall performance of the spherical roller bearing.

According to a further embodiment, the cage bars are at least partially arranged at a position in a radial direction that is offset from a pitch diameter (pitch circle). This may allow an increase in the basic dynamic load rating of the spherical roller bearing. The term “pitch diameter” and “pitch circle” describe a diameter on which the center points of the spherical rollers will run during operation.

For example, the cage bars may be arranged at a distance from the raceway of the inner or outer ring in the radial direction that corresponds to 10 to 40% of a diameter of a spherical roller, or 60 to 90% of the diameter of the spherical roller, respectively.

Arranging the cage bars at a position in a radial direction that is at least partially offset from a pitch diameter may allow a decrease in a distance between two neighboring rollers such that it may be possible to increase the number of rollers in a set of rollers. In addition, arranging the cage bars at a position in a radial direction that is at least partially offset from a pitch diameter may allow an increase of a width of the cage bar even with very small minimal roller distance. More particularly, increasing the number of rollers in the set of rollers may have the advantage that the basic dynamic load rating of the spherical roller bearing can be increased without the necessity of adapting the outer ring and/or inner ring of the bearing.

According to a further embodiment, the at least one cage may be made from sheet metal. Using sheet metal as the base material for the at least one cage may have the advantage of reducing the costs for the at least one cage. Alternatively, the cage may be made from a cast material or machined from a solid material.

According to a further embodiment, the pockets may be formed by pressing and coining and/or milling. According to a further embodiment, the axial inner cage ring consists of two separate ring elements.

Two separate cages may allow for one set of rollers to have a different rotational speed than the other row. This may reduce the forces that act on each cage compared to a cage which couple the two set of rollers. Alternatively, the first and second cage may be separate from each other, but also arranged so close to each other that it may be possible for the first and second cage to support each other while still be able to have a relative movement.

Preferably, a gap may be formed between the first and second ring elements of the axial inner cage ring. A gap between the first and second ring elements of the axial inner cage ring may allow an improvement in a lubricant flow to the inner ring of the spherical roller bearing.

According to a further embodiment, the axial inner cage ring comprises a first ring element and a second ring element which are fixed to each other. This may have the advantage that the at least one cage may be formed by two identical cages that are fixed to each other. This may allow for an easier manufacturing process for the at least one cage.

According to a further aspect, a bearing arrangement for a wind turbine main shaft is provided, wherein the bearing arrangement includes at least one spherical roller bearing as described above. All features described above with respect to the spherical roller bearing apply—separately or in combination—to the spherical roller bearing used in the bearing arrangement.

Further preferred embodiments are defined in the description and the figures. Thereby, elements described or shown in combination with other elements may be present alone or in combination with other elements without departing from the scope of protection.

### BRIEF DESCRIPTION OF THE DRAWINGS

In the following, preferred embodiments of the disclosure are described in relation to the drawings, wherein the drawings are exemplarily only, and are not intended to limit the scope of protection. The scope of protection is defined by the accompanied claims, only.

FIG. 1 is a schematic cross section of a spherical roller bearing according to an embodiment of the present disclosure.

FIG. 2: is a schematic perspective view of part of a cage of the spherical roller bearing of FIG. 1.

FIG. 3 is a schematic section along an axis of a spherical roller in a pocket of the cage of the spherical roller bearing of FIG. 1 and a line of contact between the spherical roller and the cage.

FIG. 4 is a detail view of region IV of FIG. 3.

FIG. 5 is a detail view of V of FIG. 3.

### DETAILED DESCRIPTION

In the following same or similar functioning elements are indicated with the same reference numerals.

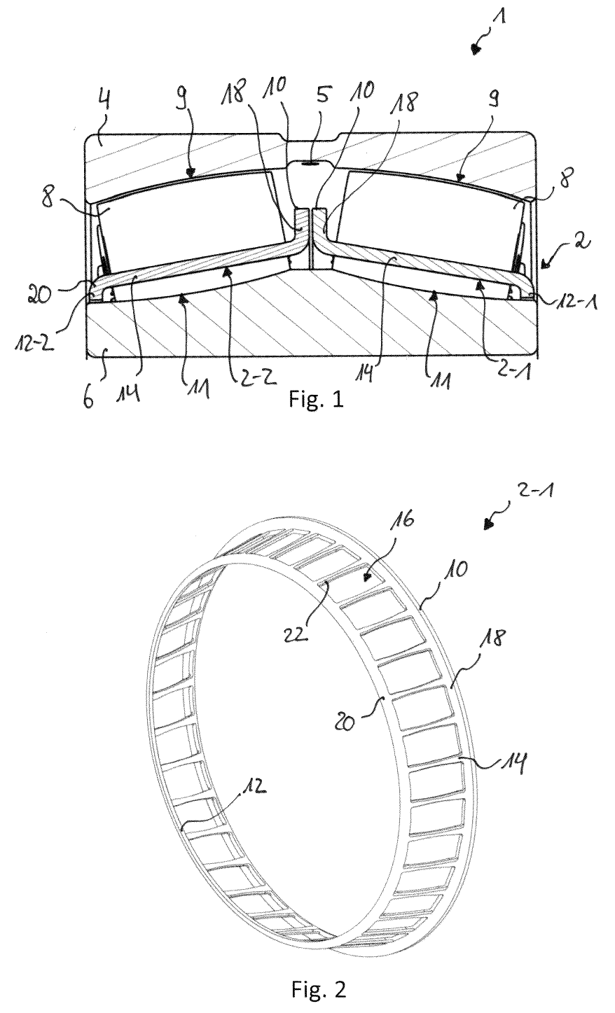

FIGS. 1 and 2 show a spherical roller bearing 1 for supporting a wind turbine main shaft as well as a part of a cage 2 of the spherical roller bearing 1.

The spherical roller bearing 1 comprises an outer ring 4, and an inner ring 6, two set of spherical rollers 8 which are configured to roll along raceways 9 formed on the outer ring 4 and on raceways 11 formed on the inner ring 6. The outer ring 4 comprises an opening 5 through which lubricant can be provided to the spherical roller bearing 1.

The inner ring 6 may be formed with or without flanges on an axial inner side and/or an axial outer side. The spherical roller bearing shown in FIG. 1 is formed without flanges on both the axial inner side and the axial outer side of the inner ring 6.

Furthermore, the spherical roller bearing comprises a cage 2 configured to retain both sets of spherical rollers 8. The cage 2 of the spherical roller bearing shown in FIG. 1 comprises a first cage element 2-1 configured to retain the first set of spherical rollers 8 and a second cage element 2-2 which are identical in shape and connected to each other to form the cage 2. FIG. 2 shows the first cage element 2-1 in detail.

As an alternative, the cage 2 may be formed in one piece such that the cage 2 comprises only one axial inner cage ring 10 instead of two axial inner cage rings 10 that are fixed to each other. Alternatively, the cage elements 2-1, 2-2 may be formed separate from each other such that a gap may be formed between the cage elements 2-1, 2-2.

Each cage element 2-1, 2-2 comprises an axial inner cage ring 10 extending in a circumferential direction of the bearing, an axial outer cage ring 12 axially spaced from the axial inner cage ring 10 and connected to it with a plurality of cage bars 14 thereby forming closed pockets 16. Each pocket 16 is configured to receive one spherical roller 8 and has an axial inner pocket side face (indicated by dashed line 40), and an axial outer pocket side face (indicated by dashed line 42) configured to confine the received spherical roller 8 in the axial direction.

The axial inner cage ring 10 has a flange element 18 radially to the outside, and the axial outer cage ring 12 has a flange element 20 radially extending to the inside.

Moreover, the cage bars 14 are at least partially arranged at a position that is at least partially offset to the radial inside of a pitch diameter of the spherical roller bearing 1. Preferably, the position corresponds to 10 to 40% of the diameter of the spherical roller 8 used in the spherical roller bearing 1.

Arranging the cage bars 14 offset to the pitch diameter may allow a decrease in a minimal distance between the raceways of two neighboring rollers 8 such that it may be possible to increase the number of rollers used in a set of rollers 8. The minimal distance Dm is determined in a condition in which the spherical rollers 8 are equally spaced in the circumferentially direction.

In particular, a ratio Dm/Dw of the minimal distance in the circumferential direction between the raceways of two neighboring spherical rollers 8 of the first and/or second set of spherical rollers to the maximal roller diameter Dw is less than or equal to 0.11, preferably 0.09, and even more preferred 0.075, when the spherical rollers 8 of the respective set of rollers 8 are equally spaced in the circumferentially direction.

Alternatively or additionally, the minimal distance Dm in the circumferential direction between the raceways of two neighboring spherical rollers of the first and/or second set of spherical rollers may be less than or equal to a value obtained by the following equation:

Dm≤0.0064 mm·(ln(P·Dw+Dw))³
when the spherical rollers 8 of the respective set of rollers 8 are equally spaced in the circumferentially direction, wherein P is the pitch diameter and Dw is the maximal roller diameter, wherein the millimeter values of P and Dw are to be used as dimensionless variables.

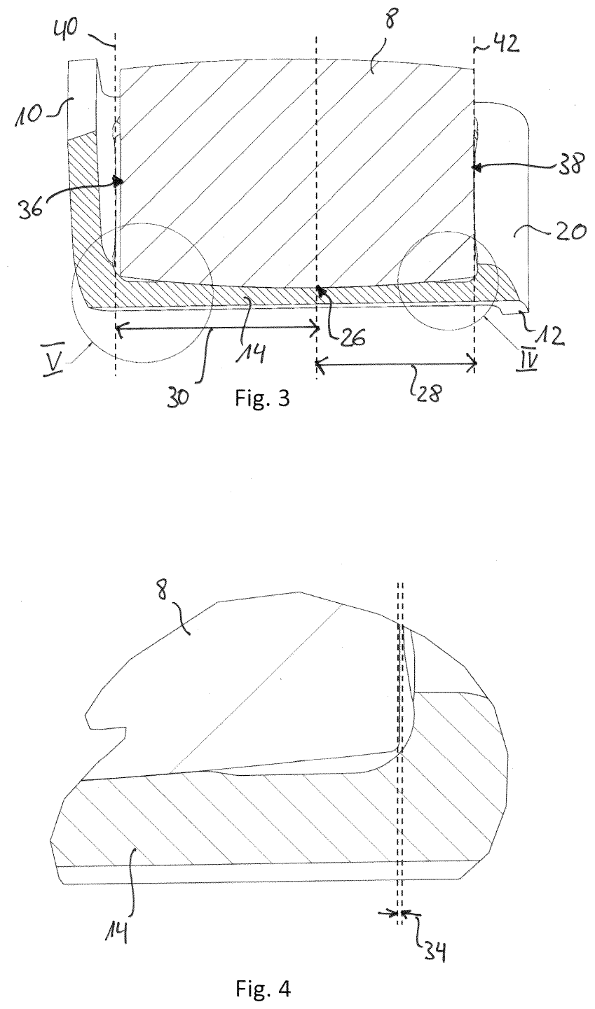

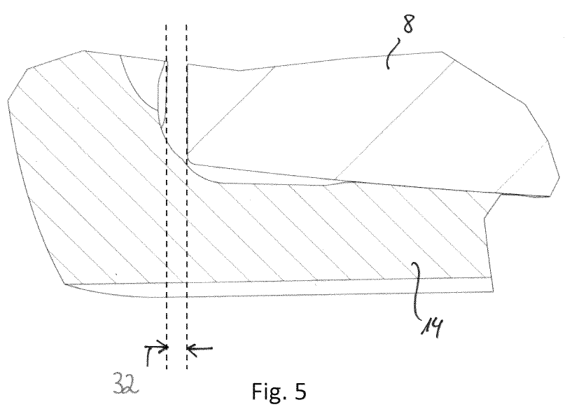

FIG. 3 shows a schematic section along an axis of the spherical roller 8 in the pocket 16 and a line of contact between the spherical roller 8 and the cage, FIG. 4 shows the detail IV of FIG. 3, and FIG. 5 shows the detail V of FIG. 3.

As can be seen from FIG. 3, the cage bar 14 has a concave curvature in the axial direction at a circumferential side face 22. The curvature is such that, in the axial direction, a distance 30 between an apex 26 of the curvature and the axial inner pocket side face 40 is larger than the distance 28 between the apex 26 of the curvature and the axial outer pocket side face 42. This results in an asymmetric cage pocket geometry.

A radius of the curvature is adapted to form an osculation with a crowning of the spherical roller 8, wherein the osculation is between 100% and 104%, preferably between 100.5% and 103%.

As can be seen from FIG. 4 and FIG. 5, an outer axial clearance 34 (FIG. 4) between the axial outer pocket side face 42 and an outer axial side face 38 of the spherical roller 8 is smaller than an inner axial clearance 32 (FIG. 5) between the axial inner pocket side face 40 and an inner axial side face 36 of the spherical roller 8.

In summary, the geometry of the cage pocket 16 may be optimized by compensating for the axial displacement of the cage 2 due to gravity and contact angle. This may result in a more precisely defined roller position in the pocket in operation. This may also allow to select a tighter osculation of the side surface 22 of the cage bar 14, which is configured to contact a surface of the spherical roller 8 receive in the pocket 16. A tighter osculation may reduce the cage bar contact stress in operation and may improve the overall performance of the spherical roller bearing.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved spherical roller bearings.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMERALS

1 spherical roller bearing
2 cage
2-1, 2-2 cage element
4 outer ring
5 opening
6 inner ring
8 spherical roller
9 outer raceway
10 axial inner cage ring
11 inner raceway
12-1, 12-2 axial outer cage ring
14 cage bar
16 pocket
18 flange element
20 flange element
22 side face
26 apex
28 distance
30 distance
32 inner axial clearance
34 outer axial clearance
36 inner roller side face
38 outer roller side face
40 axial inner pocket side face
42 axial outer pocket side face

What is claimed is:

1. A spherical roller bearing comprising:
an outer ring,
an inner ring having a bore having a diameter of at least 499 mm,
a first set of spherical rollers and a second set of spherical rollers configured to roll on a raceway of the outer ring and on a raceway of the inner ring,
at least one cage configured to retain the spherical rollers, the at least one cage comprising:
at least one axial inner cage ring,
a first axial outer cage ring spaced from the at least one axial inner cage ring on a first axial side of the at least one axial inner cage ring and connected to the at least one axial inner cage ring by a plurality of cage bars to form a plurality of closed first pockets each configured to receive one spherical roller of the first set of spherical rollers, each of the plurality of closed first pockets having an axial inner pocket side face and an axial outer pocket side face configured to axial limit the spherical roller in an axial direction, and
a second axial outer cage ring spaced from the at least one axial inner cage ring on a second axial side of the at least one axial inner cage ring and connected to the at least one axial inner cage ring by a plurality of cage bars to form a plurality of closed second pockets each configured to receive one spherical roller of the second set of spherical rollers, each of the plurality of closed second pockets having an axial inner pocket side face and an axial outer pocket side face configured to axial limit the spherical roller in an axial direction,
wherein each cage bar has an axially extending curvature in the circumferential direction,
wherein the curvature is at least partially concave, and
wherein an axial distance between an apex of the curvature and the axial inner pocket side face is not equal to a distance between the apex of the curvature and the axial outer pocket side face.

2. The spherical roller bearing according to claim 1,
wherein the distance between the apex of the curvature and the axial inner pocket side face is larger than the distance between the apex of the curvature and the axial outer pocket side face.

3. The spherical roller bearing according to claim 2, wherein a radius of the curvature is configured to form an osculation with a crowning of the spherical roller.

4. The spherical roller bearing according to claim 3, wherein the osculation is between 100% and 104%.

5. The spherical roller bearing according to claim 3, wherein the osculation is between 100.5% and 103%.

6. The spherical roller bearing according to claim 5, wherein an outer axial clearance between the axial outer pocket side face and an outer axial side face of the spherical roller is smaller than an inner axial clearance between the at least one axial inner pocket side face and an inner axial side face of the spherical roller.

7. The spherical roller bearing according to claim 2,
wherein the cage bars of the first axial outer cage ring are radially offset from a pitch circle of the rollers.

8. The spherical roller bearing according to claim 7, wherein the cage bars are offset radially inward relative to the pitch circle.

9. The spherical roller bearing according claim 2, wherein the axial inner cage ring comprises a first ring element and a separate second ring element.

10. The spherical roller bearing according to claim 9, wherein an axial gap is formed between the first ring element and the second ring element.

11. The spherical roller bearing according claim 2, wherein the axial inner cage ring comprises a first ring element and a second ring element fixed to the first ring element.

12. The spherical roller bearing according to claim 2, wherein the at least one cage comprises sheet metal.

13. The spherical roller bearing according to claim 2,
wherein a radius of the curvature is configured to form an osculation between 100% and 104% with a crowning of the spherical roller,
wherein an outer axial clearance between the axial outer pocket side face and an outer axial side face of the spherical roller is smaller than an inner axial clearance between the at least one axial inner pocket side face and an inner axial side face of the spherical roller, and
wherein the cage bars of the first axial outer cage ring are offset radially inward from a pitch circle of the rollers.

14. A bearing arrangement for a wind turbine main shaft including at least one spherical roller bearing according to claim 13.

15. A bearing arrangement for a wind turbine main shaft including at least one spherical roller bearing according to claim 2.
